(19) United States
(12) Patent Application Publication
(10) Pub. No.: US 2009/0219987 A1
(43) Pub. Date: Sep. 3, 2009

(54) Method and Device for Generating a Marked Data Flow, Method and Device for Inserting a Watermark Into a Marked Data Flow, and Marked Data Flow

(76) Inventors: Gero Bäse, München (DE); Ivan Kopilovic, München (DE); Marcel Wagner, München (DE)

Correspondence Address: STAAS & HALSEY LLP, SUITE 700, 1201 NEW YORK AVENUE, N.W., WASHINGTON, DC, 20005, US

(21) Appl. No.: 12/087,285

(22) PCT Filed: Dec. 6, 2006
(86) PCT No.: PCT/EP2006/069307

§ 371 Date: Oct. 22, 2008

(30) Foreign Application Priority Data
Dec. 30, 2005 (DE) 102005063136.3

(51) Int. Cl. H04N 11/02; H04L 9/32; H04N 7/167

(52) U.S. Cl. 375/240.01; 713/176; 380/217

(57) ABSTRACT

A method generates a marked data flow from an encoded data flow; at least one first data flow section of the encoded data flow is marked as a marked data flow section; and the marking of the marked data flow section indicates that the marked data flow section is suitable to be mixed with a watermark. A method inserts watermarks into the marked data flow, and devices generate the marked data flow and insert watermarks into the marked data flow.

### CROSS REFERENCE TO RELATED APPLICATIONS

This application is based on and hereby claims priority to German Application No. 10 2005 063 136.3 filed on Dec. 30, 2005 and PCT Application No. PCT/EP2006/069307 filed on Dec. 5, 2006, the contents of which are hereby incorporated by reference.

### BACKGROUND OF THE INVENTION

The invention relates to a method and a device for generating a marked data flow, a method and a device for inserting a watermark into a marked data flow as well as a marked data flow.

The introduction of the digitization of multimedia information, such as for example, pictures, videos or pieces of music has made both unauthorized copying and illegal distribution of such content substantially easier. In such cases, multimedia information can be easily processed, such as for example by compressing music pieces by MP3 or burning feature films onto DVD (DVD-—Digital Video Disc) by the MPEG compression process (MPEG—Motion Picture Expert Group).

In order to avoid or make more difficult the unauthorized copying and/or illegal distribution of multimedia information, in the past a plurality of technologies was developed within the range of Digital Rights Management (DRM). One of the DRM technologies uses digital signatures to provide protection from illegal copies. In this case, the digital contents are encoded by using a key. A user can read and process the encoded information only by using a further key. Another DRM technology uses watermarks. In this case, watermarks are mixed in such a manner with the multimedia information that the mixed multimedia information does not show any noticeable qualitative degradation of the multimedia information for a user. With the aid of suitable algorithms, a watermark in mixed multimedia information can be reconstructed and in this way proven.

A problem with the protection of digital multimedia information is presented by the so-called analog hole. Digital information such as for example digital video data is transmitted encoded during the transmission from a video server to a set top box of a user. In the set top box, a decoding and mostly a decompression of this digital information take place. Subsequently, the decoded and decompressed digital information can for example be played via a loudspeaker and/or viewed via a monitor. When this is done, the loudspeaker and the monitor are activated with a specific analog signal which is created by a digital/analog conversion of the decompressed digital information. Since these analog signals are easily accessible, they can be recorded for unauthorized copying for example by a video recorder. This is referred to as “analog hole”. In order to be able to identify such copies, devices such as a watermark may be employed, which is for example embedded in the images of the video data.

Apart from the embedding of protective mechanisms to detect unauthorized copies in digital information, it is also necessary to be able to determine which user made the unauthorized copies or passed these on without authorization. For this purpose, watermarks can be created individually for each user.

Individual, i.e. user-specific watermarks can be inserted by inserting individual watermarks into the digital information, as a result of which the digital information is compressed. This procedure has the disadvantage that, on the one hand, digital information has to be processed or compressed individually for each user. On the other hand, digital information is present in compressed form on a server in the case of on-demand services. In this case, the compressed information must be decompressed individually for each user, an individual watermark inserted and subsequently the digital information provided with the watermark must be compressed once again. This procedure is not economically viable since, besides providing a large amount of memory space, the on-demand server must provide high computing power.

Furthermore, the advantages of a multicast distribution such as for example the unique transmission of the compressed digital information from the on-demand server to a node in the network, which takes over the further distribution to individual users, cannot be used in the case of this procedure.

Thus, in [1] for the video compression method MPEG-2, the known practice is to carry out a partial decoding in a set top box, i.e. on the user-side, after a decoding of the video data, i.e. visual information. In this case, for one image block of the video data or a plurality of image blocks of the video data, partial decoding is implemented in such a manner that decoding up to the presentation of the transformation coefficients is carried out. These transformation coefficients are mixed with a watermark. Subsequently, the transformation coefficients mixed with the watermark are again encoded so that a valid MPEG-2 video data flow is produced.

The disadvantage of this procedure is that for existing set top boxes, a partial decoding of the encoded data flow is already too complex with regard to computing power and amount of memory. Thus for example in the video compression standard ITU H.264 (ITU—International Telecommunications Union), which is also known as MPEG-4-AVC or ISO/IEC 14496-10, an arithmetic encoding referred to as CABAC encoding (CABAC—Context Adaptive Binary Arithmetic Coding) is used. The CABAC encoding is an adaptive compression method with high computing outlay, in the case of which the information about an image or parts of it is stored in only a single indivisible code word. In order to be able to access individual information of the image, the code word generated by the CABAC encoding must be completely decoded.

### SUMMARY

One potential object is to describe a method or a device for generating a marked data flow from an encoded data flow or a method and a device for inserting a watermark into a marked data flow, which makes possible the inserting of individual watermarks into the encoded data flow for random compression methods with low complexity.

In the method for generating a marked data flow from an encoded data flow proposed by the inventors, encoded multimedia information is at least contained in a first data flow section of the encoded data flow, the first data flow section of the encoded data flow is marked as a marked data flow section, and the marking of the marked data flow section indicates that the marked data flow section is suitable to be mixed with a watermark.

This method makes it possible, by using an encoding device, for example in a transmitter, for at least one first data flow section to be selected, i.e. marked, which is for example provided with a watermark in an insertion device, for example in a user-side set top box. In this case, the encoding device can take into account that the mixing of a first data flow section with a watermark should only take place in those first data flow sections which can be processed with a low complexity. In practice it can be appropriate in this case for the encoding device to create marked first data flow sections with low-complexity algorithms.

The marked data flow section can in particular be processed without due consideration of other data flow sections. In this case, the encoding device can make provision for the fact that a used coding pattern of other first and/or second data flow sections has no influence on the encoding pattern of the marked data flow section. An arithmetic encoding for the marked data flow section is for example created separately, i.e. independently of other data flow sections.

In an embodiment, the marking information is inserted into the encoded data flow in the form of a second data flow section (DA2), with the marked data flow section being localized with the aid of the marking information. This enables localization of the marked data flow sections to be carried out in a simple and economical way.

In this case, the marking information is preferably given precedence to the marked data flow section. This makes possible an identification of the marked data flow sections without intermediate storage of the marked data flow section. In this case, in an appropriate embodiment, the preceding marking information that is given precedence is created in the form of an SEI message in accordance with the standard H.264. In this way, a standardized implementation of the method can be made possible for the H.264 standard.

In an alternate embodiment, the marking information follows the marked data flow section. In this case, it is ensured that the contents of the marked data flow section are made available immediately on the basis of the marking information preceding it. In such cases it is expedient to create the marking information following the section in the form of an NAL unit in accordance with the standard H.264. With this, a standardized implementation of the method can be achieved for the standard H.264.

Preferably, the marked data flow section describes a group of image blocks whereby the method can be used in a block-based encoding method.

If the marked data flow section is localized by a specific encoding characteristic of the marked data flow section, then the marked data flow section can be identified without a signaling field. The method can thus be implemented without increasing the volume of data.

In this case, the specific coding characteristic can be defined by a predeterminable number of image blocks. This encoding characteristic can be identified with a low computing complexity. In addition or as an alternative, the specific encoding characteristic can be shown by a minimum size of an image block within the marked data flow section. This encoding characteristic can be identified without carrying out at least a partial decoding of the encoded data flow. In an optional development, the image blocks of the marked data flow section are created in accordance with an intra-encoding mode. This ensures that the marked data flow section is able be decoded without taking account of the other first data flow sections and the watermark can thus be inserted with a low computing overhead and/or memory requirement.

In a preferred embodiment, at least a part of a plurality of image blocks of the marked data flow section is mixed with the watermark. In this way, the computing power required for inserting the watermark can be further reduced, since a number of image blocks to be processed per marked data flow section are decreased.

Preferably, the marked data flow section is created by excluding an arithmetic encoding so that dependencies in encoding the marked data flow section can be avoided by other data flow sections.

Furthermore, the inventors propose a method for inserting a watermark into a marked data flow in the case of which a marked data flow section is localized in the marked data flow, a mixed data flow section is created by mixing the watermark and the localized and marked data flow section that is integrated in such a way with the data flow section in the marked data flow mixed with the watermark that the mixed data flow section replaces the localized marked data flow section. By this method of insertion, the mixing of the marked data flow section with the watermark can for example be carried out in a set top box in a simple and fast way on the part of the receiver. In this case, in particular a user-specific watermark can be inserted at a low cost.

In addition, the inventors propose a device for generating a marked data flow from an encoded data flow, with an encoding device for marking at least one first data flow section of the encoded data flow as the marked data flow section, with the marking of the marked data flow section indicating that the marked data flow section is suitable to be mixed with a watermark and with encoded multimedia information being contained in the encoded data flow by the first data flow section. The method for generating a marked data flow is able to be implemented with the aid of this device.

Furthermore, the inventors propose a device for inserting a watermark into a marked data flow with an insertion device for localizing a marked data flow section in the marked data flow, for mixing the watermark and the localized and marked data flow section in a mixed data flow section and for integrating the mixed data flow section in the marked data flow, with the mixed data flow section replacing the localized marked data flow section. The method for inserting a watermark into a marked data flow is able to be implemented with the aid of this device.

The inventors propose furthermore to a marked data flow which is created by using the method for generating an encoded data flow. The generated data flow can be transmitted from a transmitter to a receiver. Furthermore, it can be stored on a storage medium, for example a storage disk or a memory chip in an organized manner.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 a device for creating a marked data flow for inserting a watermark as well as a device for inserting a watermark into a marked data flow;

FIG. 2A an encoded data flow with first and second data flow sections;

FIG. 2B, 2C in each case a marked data flow with first and second data flow sections;

FIG. 3 an example of a flowchart for generating a marked data flow with the first data flow sections of the marking information that is given precedence;

FIG. 4 a further example of a flowchart for generating a marked data flow with the marking information following the first data flow sections;

FIG. 5 the structure of a first data flow section;

FIG. 6 using the method or the device for generating the marked data flow or for inserting the watermark into the marked data flow.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

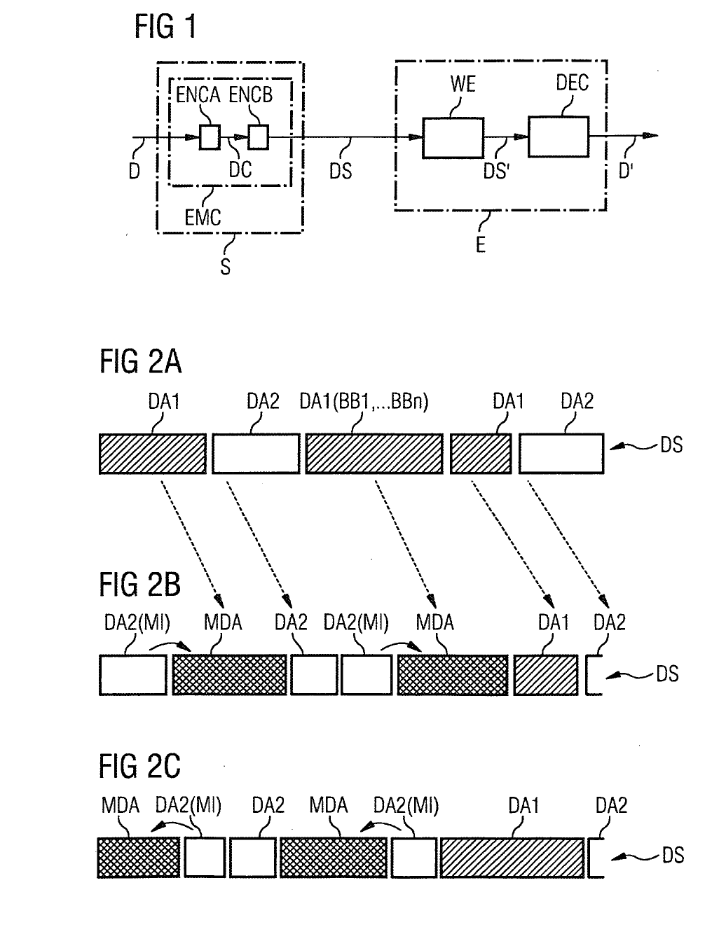

In FIG. 1, a data flow D, which for example contains an sequence of images, is encoded in an encoded data flow DC. The encoding is carried out by a first encoding module ENCA. In general, encoding means a specification in which the symbols of one representation will be transferred into symbols of another. Within the framework of this description, encoding results in a compression of information. This is for example achieved with a standardized encoding method such as is for example used for the compression of visual information with a video encoding method in accordance with MPEG-1, MPEG-2 or H.264. Within the framework of this document, information means multimedia information such as for example videos, images or music pieces. A person skilled in the art is well acquainted with the encoding methods for the compression of multimedia information so that this is not explained in more detail. In principle, standardized and/or non-standardized encoding methods for the compression of multimedia information can be used. The proposed method can be used for any type of multimedia information. The methods and devices are described by way of examples below on the basis of video sequences.

FIG. 2A shows a section of an encoded data flow DC continuous in time. This encoded data flow DC contains first and second data flow sections DA1 and DA2. A data flow section in each case means a coherent range of the encoded data flow DC in the case of which encoded information belonging together because of its content is collected together.

The first data flow section DA1 represents encoded multimedia information of the data flow D to be coded. In a data flow DC, encoded in accordance with MPEG-1, four image blocks with luminosity information and two image blocks with color information are for example coded combined into one macro block. In this case, such a macro block represents encoded multimedia information of the data flow D to be encoded, i.e. the first data flow section DA1. Furthermore, the first data flow section DA1 can also be created by combining a plurality of macro blocks. In MPEG-1 this is referred to as the ‘slice’.

By the second data flow section DA2, control information about the encoded data flow DC is described. In MPEG-1, a sequence header is for example used, which among other things gives a height and a width of the images of an image sequence. Furthermore in MPEG-1, a picture header is for example used, which contains information about the current image to be encoded.

If the video encoding standard H.264 is considered instead of the video encoding standard MPEG-1, then data flow sections are defined there by the so-called NAL units (NAL—Network Adaptation Layer). In principle, the NAL units can be divided into two categories. The one category contains control information such as for example information about the size of the image or a number of images per second. This category represents the second data flow sections DA2. At the same time there are NAL units such as for example a group of macro blocks referred to as VLC-NAL (VLC—Video Coding Layer) or slice, which contains the image information to be encoded of the data flow D to be encoded. This other category of NAL units corresponds to the first data flow sections DA1.

The generation of the encoded data flow DC is carried out in accordance with FIG. 1 by the first encoding module ENCA. In this process, the data flow D to be encoded such as for example an image sequence is encoded in slices. Such a slice represents a first data flow section DA1. If a slice or the blocks of a slice are to be mixed with a watermark WM in a later processing step, then this first data flow section DA1 is first of all provided with a marking. Such a marked first data flow section DA1 is referred to as a marked data flow section MDA. The marking is carried out in a second encoding module ENCB. The first and the second encoding module can be integrated in an encoding device ENC. An encoded data flow which has been marked is referred to as a marked data flow DS.

In a first exemplary embodiment, for the marking of a first data flow section, i.e. of the slice, a second data flow section DA2, which contains the marking information MI is placed in the encoded data flow ahead of the first data flow section DA1 to be marked in time. As shown in FIG. 2B in the case of this variant, a second data flow section with the marking information DA2 (MI) is in each case inserted directly ahead of the slice to be marked in the encoded data flow DC. The marked encoded data flow is referred to as a marked data flow DS and the marked slice as a marked data flow section MDA. This connection is represented by semicircular arrows in FIG. 2B. The end of the arrow begins with that second data flow section, which marks a following first data flow section. The head of the arrow points to the marked data flow section MDA. The marked slices are marked with a diamond pattern. Broken-line arrows between FIG. 2A and FIG. 2B show identical first data flow sections DA1 or marked data flow sections MDA on the basis of contents. When using H.264, the marking information can be generated by an SEI message (SEI—Supplementary Enhanced Information) for example with an “MI=payload-Type=22”.

In a further example for the marking of a first data flow section, for example of a slice, a second data flow section DA2 with the marking information MI follows in time after a first data flow section DA1 to be marked. As can be seen in FIG. 2C, a second data flow section DA2 with the marking information MI is inserted directly behind the slice to be marked, i.e. the first data flow section DA1 to be marked. Semicircular arrows in FIG. 2C illustrate this connection. In this example, for H.264 the second data flow section DA2 can be created with the marking information by an NAL unit with an NAL type “nal-unit_type=30”.

Thus the marked data flow DS contains the first and the second data flow sections DA1, DA2, with the marked data flow section MDA able to be localized by using the marking information MI in the marked data flow DS.

This marked data flow DS can be transmitted from a transmitter S containing the encoding device ENC to a receiver E. The transmitter S can be embodied as an on-demand server and the receiver E as a set top box. The marked data flow DS for example is transmitted via the IP-based Internet (IP—Internet Protocol).

The encoding device ENC is for example implemented by the first encoding module ENCA and the second encoding module ENCB. The first encoding module ENCA contains a commercial encoding module, for example in accordance with a standardized video encoding standard. An encoded data flow DC generated by the first encoding module ENCA is supplied to the second encoding module ENCB. This second encoding module ENCB selects one first data flow section or a plurality of first data flow sections to be marked in the generated data flow and inserts or in accordance with FIG. 2B the marking information into the generated data flows. The second encoding module ENCB selects the first data flow sections to be marked or in accordance with an encoding characteristic. The use of encoding characteristics is described at a later stage. The second encoding module ENCB generates the marked data flow DS.

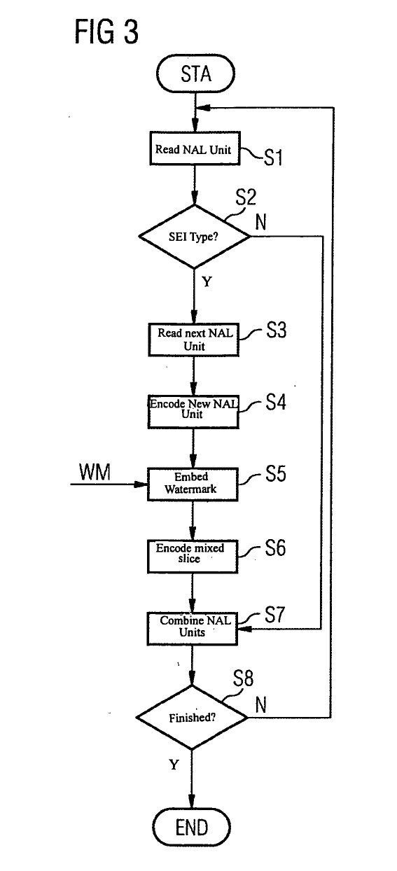

The received marked data flow DS of an insertion device WE is supplied to the receiver E for inserting the watermark. Inserting the watermark into the marked data flow is explained in greater detail by FIG. 3 on the basis of the marking information Ml preceding in each case the marked data sections MDA in accordance with an exemplary embodiment according to the video encoding standard H.264. In this case, the marked data flow DS was created in accordance with FIG. 2B, with NAL units with an SEI message containing for example a “payloadType=22” being inserted as the marking information M as the second data flow sections DA2 for marking the marked data flow sections MDA, I.

After the start of the flowchart in accordance with FIG. 3, in a first step S1, an NAL unit is read in from the marked data flow DS in the STA state. In a second step S2, the special type of read-in NAL unit is determined. If this is an SEI type with the “payloadType=22”, it can be concluded that this corresponds to the preceding marking information MI of the marked data flow section MDA. In this case, a third step S3 is invoked. Otherwise the process continues with a step S7.

The next NAL unit is read in, in a third step S3. Subsequently, this newly read-in NAL unit, which corresponds to the marked slice or the marked data flow section MDA, is encoded. The encoding is carried out in the fourth step S4. A watermark WM is embedded in the decoded slice in the fifth step S5. Methods for this are for example known from [1]. In a subsequent step S6, the slice mixed with the watermark is encoded.

In the seventh step S7, the newly encoded slices, i.e. newly encoded NAL units and the non-processed NAL units are combined in their read-in sequence into a modified encoded data flow DS′. In the eighth step S8 a check is carried out in order to determine as to whether the end of the marked data flow DS has been reached. If this is the case, then the flowchart is terminated in the END state. Otherwise, the flowchart is continued with the first step S1.

In the exemplary embodiment in accordance with FIG. 3, those second data flow sections DA2 which contain the marking information MI for the data flow sections MDA to be marked are not transferred to the modified encoded data flow DS′. Optionally to this, these second data flow sections DS2 are also inserted into the modified encoded data flow DS′, since a downstream decoder DEC, which generates a decoded data flow D′ from the modified encoded data flow DS′, ignores the second data flow sections DA2 with the marking information during decoding. The decoded data flow D′ for example contains uncoded image data with for example an 8 bit color value in each case for the colors red, green and blue for each pixel of the uncoded image date. In addition to this representation, luminance values and crominanz values can also describe a pixel. Further forms of representation are known to a person skilled in the art.

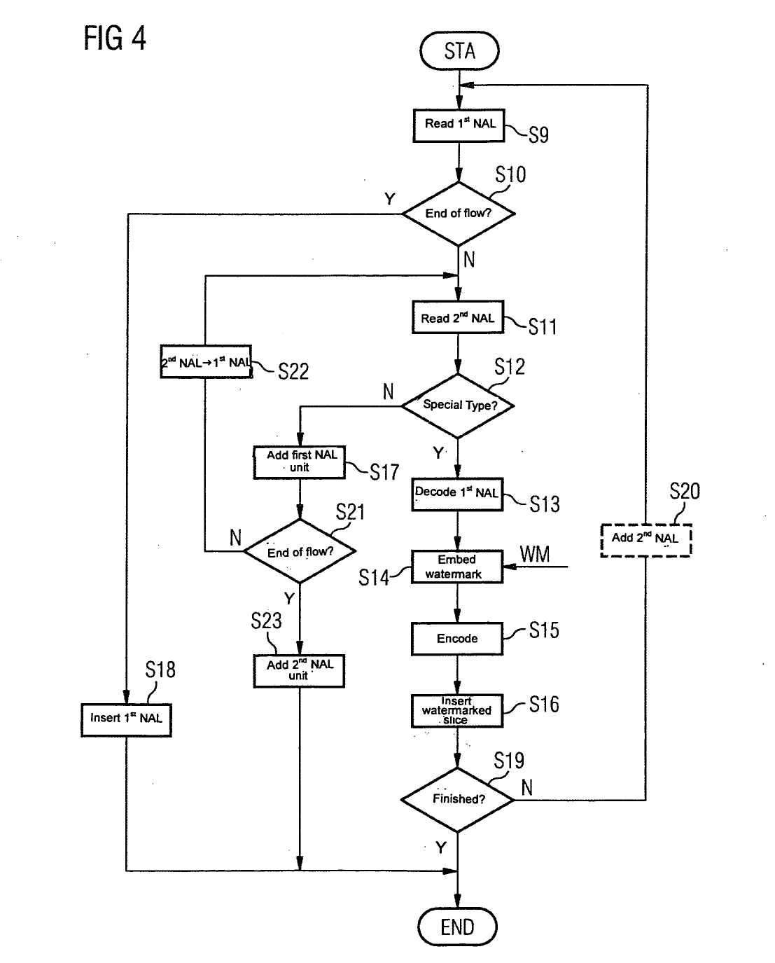

With the aid of FIG. 4, a procedure for inserting watermarks into the marked data flow by using trailing marking information MI is described in greater detail below. In this case, the marked data flow DS indicates a structure in accordance with FIG. 2C. In this process, the second data flow sections with the marking information DA2 (MI) are in each case represented by using an NAL unit of an “nal_unit_type=30”. After the start of this flowchart in the STA state, in the ninth step S9 a first NAL unit is first of all read in. In the subsequent tenth step S10, a check is carried out in order to determine whether the end of the marked data flow DS has been reached. If this is the case, the first read-in NAL unit is inserted into the end of the modified encoded data flow DS′ in the eighteenth step S18. The flowchart is subsequently terminated with the END state.

If in the tenth step S10, the end of the marked data flow DS has not been reached, a second NAL unit will then be read in, in the eleventh step S11. This second NAL unit is checked in the twelfth step S12 so as to determine whether it corresponds to a special NAL type for example an NAL type with an “nal_unit_type=30”. If this is not the case, then the second NAL unit is not a second flow section DS2 which contains the marking information MI. In this case, the process continues with a seventeenth step S17, in which case the first read-in NAL unit is added to the end of the modified encoded data flow DS′. Subsequently, in the twenty first step S21 a check is carried out in order to determine whether the end of the marked data flow DS has been reached. If this is the case, in a twenty third step S23, the second NAL unit is added to the end of the modified encoded data flow DS′ and the flowchart is terminated with the END state. If the end was not determined in step S21, then the second NAL unit becomes the first NAL unit in the twenty second step S22. The process then continues with the eleventh step S11.

If in the twelfth step S12, a second data flow section DA2 with the marking information MI was detected, the process continues with a thirteenth step S13. In this case, the first NAL unit, which corresponds to the marked slice MDA is decoded or at least partially encoded. In the fourteenth step S14, the watermark WM embedded in the decoded slice and the slice provided with the embedded watermark is encoded in the fifteenth step S15. Subsequently, in the sixteenth step S16, the encoded slice is positioned at the end of the modified encoded data flow DS′. Subsequently, in the nineteenth step S19 a check is carried out in order to determine whether the end of the marked data flow DS has been reached. As described before, in this case either the flowchart is terminated in the END state or the flowchart continues with the ninth step S9.

In an extension of the flowchart in accordance with FIG. 4, a twentieth step S20 can be inserted between the steps S19 and S9. Step S20 is drawn as a broken line. In this case, the second NAL unit is optionally added to the end of the modified encoded data flow DS′ and can remain unconsidered during a later decoding. In practice, the use of this option can be advantageous because by using the second data flow sections, which contain the marking information, the marked data flow sections can for example for inspection purposes or when changing the watermark, be found quickly and simply in the modified, encoded data flow.

As described by FIGS. 2 to 4, slices can be merged in the form of marked data flow sections MDA with the watermark. A slice contains one macro block or a plurality of macro blocks, with each macro block containing a plurality of image blocks BB1, . . . BBn. In accordance with an extension, the marking information Ml can furthermore contain the information as to which image blocks or macro blocks of a slice is to be used for merging with the watermark. In this process, although the complete slice can be decoded, an embedding of the watermark only takes place in the case of the image blocks or the macro blocks which were marked on the basis of the marking information MI. In this process, an additional field can be inserted within the marking information, which for each image block contained in the slice indicates by an instruction or a binary instruction as to whether the specific image block is suitable to be merged or not with the watermark signal. Only when the specific image block is suitable for merging can a merging actually be carried out, with it not being mandatory for each image block which is suitable for the merging to be provided with a watermark. The insertion device WE for example decides to mix only each third suitable image block or marked data flow section with a watermark. Furthermore, the insertion device WE can decide on the basis of a complexity for carrying out the mixing which marked data flow sections or blocks suitable for mixing with the watermark are mixed, with the complexity for carrying out the mixing not exceeding a predeterminable threshold value.

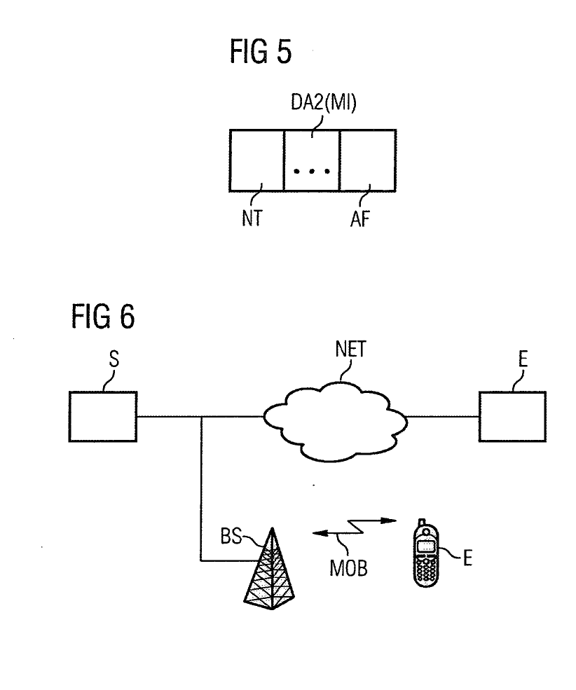

In FIG. 5, a second data flow section DA2 is shown by way of example, which comprises, in addition to the NAL type “NT=nal_unit_type=30”, an information field AF, which in each case represents one bit for a specific image block in the slice belonging to it. The first bit with a value of “0” indicates that a first image block in the slice should not be provided with a watermark. The second bit, with a value of “1” indicates that the second image block in the slice is to be merged with the watermark. The further bits are to be used accordingly on further image blocks in the slice. In this manner the AF field can amount to “0, 1, 1, 0, 0”.

In the above exemplary embodiment, it has been explicitly indicated by a second data flow section DA2, which contains the marking information MI, that the first data flow section DA1 belonging to the second data flow section DA2 is to be marked. In a variant of this, the marked data flow section can be localized and detected by it being detected on the basis of at least one predeterminable specific encoding characteristic of the first data flow section that this first data flow section is or is not a marked data flow section. For example, four macro blocks are always encoded in a marked data flow section. On the other hand, data flow sections which have not been marked are always encoded with a number of macro blocks not equal to four. A person skilled in the art in the area of video encoding or other encoding methods knows, in addition to determining a number of macro blocks per marked data flow section, other encoding characteristics that can be used to make a distinction between marked and unmarked data flow sections. A certain block size of the encoded image blocks or a quantization value is for example used as an alternative or in addition to the number of macro blocks per marked data flow section.

The use of marked data flow sections MDA makes it considerably easier for the insertion device WE to detect only marked data flow sections on the basis of the marking information. This procedure is computationally not very complex and requires a small memory capacity for the buffering of the first or the second data flow sections.

In an extension, a complexity for inserting watermarks can be reduced by the fact that marked data flow sections can be decoded and encoded in a simple way. This is for example achieved by the fact that a small number of macro blocks or image blocks are used per marked data flow section MDA. Furthermore by using image blocks with a minimum size within the marked data flow sections, a further reduction of the processing complexity for decoding and encoding the image blocks of marked data flow sections can be achieved. In addition, a simplification can be made possible by the fact that the individual image blocks of the marked data flow section are created by an intra-encoding mode. In this case, when selecting the data flow section to be marked, the encoding dependencies such as for example a temporarily preceding image, must not be taken into consideration. A continuing simplification for encoding or decoding a marked data flow section can be attained by the fact that no arithmetic encoding is used. This in particular has the advantage that for example image blocks can be processed block-by-block within the marked data flow section without an expensive decoding of all the image blocks of the marked data flow section. In particular, a considerable simplification of the processing complexity can be achieved by an explicit instruction of the marking information for those image blocks, which are to be merged with the watermark.

Two implementation variants are shown in FIG. 6. The transmitter S, for example a, video server, contains the device for generating the marked data flow. The marked data flow can be transmitted via a network NET, for example an IP-based LAN (IP—Internet Protocol, LAN—Local Area Network), to the receiver such as for example a set top box or a computer. As an alternative to that, the marked data flow can be transmitted wirelessly from a base station BS to the receiver E, for example a mobile radio device, with the wireless transmission MOB being for example carried out in accordance with the GSM, the UMTS or the WLAN standard (WLAN—Wireless Local Area Network, GSM—Global System for Mobile Communication, UMTS—Universal Mobile Telecommunications System).

The receiver E contains the insertion device WE and the decoder DEC as an option. This makes it possible for a user-specific watermark to be inserted by the receiver, i.e. via the subscriber terminal. In a further embodiment, the insertion device can be integrated in the transmitter S so that only the decoder DEC is required in the specific receiver E.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-18. (canceled)

19. A method for generating a marked data flow from an encoded data flow, comprising:
transmitting encoded multimedia information in at least a first data flow section of the encoded data flow;
marking the first data flow section of the encoded data flow as a marked data flow section; and
using the marking of the marked data flow section to indicate that the marked data flow section is suitable to be mixed with a watermark.

20. The method as claimed in claim 19, wherein,
marking information is inserted into the encoded data flow in the form of a second data flow section, and
the marking information is used to localize the marked data flow section.

21. The method as claimed in claim 20, wherein the marking information precedes the marked data flow section such that the marking information is leading marking information.

22. The method as claimed in claim 21, wherein the leading marking information is created in the form of a Supplementary Enhanced Information (SEI) message in accordance with H.264 video compression.

23. The method as claimed in claim 20, wherein,
the marking information follows after the marked data flow section such that the marking information is trailing marking information.

24. The method as claimed in claim 23, wherein the trailing marking information is created as a Network Adaptation Layer (NAL) unit in accordance with H.264 video compression.

25. The method as claimed in claim 19, wherein,
a group of image blocks is described by the marked data flow section.

26. The method as claimed in claim 19, wherein,
a specific encoding characteristic is used for the marked data flow section, and
the specific encoding characteristic is used to localize the marked data flow section.

27. The method as claimed in claim 26, wherein,
the specific coding characteristic is defined by a predeterminable number of image blocks within the marked data flow section.

28. The method as claimed in claim 26, wherein,
the specific encoding characteristic is identified by a minimum size of an image block within the marked data flow section.

29. The method as claimed in claim 26, wherein,
image blocks of the marked data flow section are created in accordance with an intra-encoding mode.

30. The method as claimed in claim 26, wherein
the data flow section contains image blocks, and
the method further comprises mixing at least a portion of the image blocks of the marked data flow section with the watermark.

31. The method as claimed in claim 19, wherein,
the marked data flow section is created by excluding an arithmetic encoding.

32. The method as claimed in claim 22, wherein,
a group of image blocks is described by the marked data flow section.

33. The method as claimed in claim 32, wherein,
a specific encoding characteristic is used for the marked data flow section, and
the specific encoding characteristic is used to localize the marked data flow section.

34. The method as claimed in claim 33, wherein,
the specific coding characteristic is defined by a predeterminable number of image blocks within the marked data flow section.

35. The method as claimed in claim 34, wherein,
the specific encoding characteristic is identified by a minimum size of an image block within the marked data flow section.

36. The method as claimed in claim 35, wherein,
image blocks of the marked data flow section are created in accordance with an intra-encoding mode.

37. The method as claimed in claim 36, wherein
the data flow section contains image blocks, and
the method further comprises mixing at least a portion of the image blocks of the marked data flow section with the watermark.

38. The method as claimed in claim 37, wherein,
the marked data flow section is created by excluding an arithmetic encoding.

39. A method for inserting a watermark into a marked data flow containing encoded multimedia information in at least a first data flow section, the first data flow section being marked as a marked data flow section, comprising:
localizing the marked data flow section;
mixing the watermark with the marked data flow section after localizing the marked data flow section, to thereby create a mixed data flow section; and
replacing the marked data flow section with the mixed data flow section such that the watermark is integrated into the encoded data flow.

40. A device for generating a marked data flow from an encoded data flow containing encoded multimedia information in a first data flow section, comprising:
an encoder to mark the first data flow section of the encoded data flow as a marked data flow section, with the marked data flow section indicating that the marked data flow section is suitable to be mixed with a watermark.

41. A device for inserting a watermark into a marked data flow containing encoded multimedia information in at least first data flow sections, the first data flow sections being marked as a marked data flow sections, the device comprising:
an insertion device to:
localize the marked data flow sections in the marked data flow;
mix the watermark with the marked data flow sections after localization to thereby create mixed data flow sections; and
replace the marked data flow sections with the mixed data flow sections to thereby integrate the watermark in the marked data flow.
